(19) United States
(12) Patent Application Publication
(10) Pub. No.: US 2009/0180445 A1
(43) Pub. Date: Jul. 16, 2009

(54) HIGH-SPEED QoS HANDOVER METHOD AND PROCESSING NODE USED IN THE METHOD

(75) Inventor: Toyoki Ue, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD, Osaka (JP)

(21) Appl. No.: 12/295,125

(22) PCT Filed: Mar. 29, 2007
(86) PCT No.: PCT/JP2007/056998

§ 371 Date: Sep. 29, 2008

(30) Foreign Application Priority Data
Mar. 31, 2006 (JP) 2006-101187

(51) Int. Cl. H04W 36/30

(52) U.S. Cl. 370/332

(57) ABSTRACT

A technology is disclosed that can provide a high-speed QoS handover method and a processing node used in the method, in which a QoS path reconfigured before a handover becomes as optimal a QoS path as possible after the handover, thereby reducing load of route reconfiguration of the QoS path performed after the handover, shortening a segment of QoS path setting performed immediately after the handover, and minimizing a QoS interruption time. The technology includes a step at which a mobile node 10 transmits a first signaling for configuring a predetermined QoS path to a processing node that performs a predetermined process for reducing a load of a modification process for a QoS path after a handover, and a step at which the processing node that receives the first signaling generates a second signaling for performing a QoS setting of the predetermined QoS path based on the received first signaling and transmits the generated second signaling to a predetermined correspondence partner that performs the QoS setting of the predetermined QoS path.

### TECHNICAL FIELD

The present invention relates to a high-speed QoS handover method and a processing node used in the method for a mobile terminal (mobile node) performing wireless communication. In particular, the present invention relates to a high-speed QoS handover method and a processing node used in the method for a mobile node that performs wireless communication using mobile internet protocol version 6 (IPv6) that is a next-generation internet protocol.

### BACKGROUND ART

Next Steps In Signaling (NSIS) is becoming standardized as a new signaling protocol by a NSIS working group of the Internet Engineering Task Force (IETF) (refer to Non-patent Document 1 below). NSIS is expected to be particularly effective for Quality of Service (QoS) resource reservations. Recent internet drafts describe the necessity of and proposals regarding implementation of QoS signaling and mobility support in other NSIS (refer to Non-patent Documents 2 to 4 below), in addition to common NSIS (refer to Non-patent Documents 5 and 6 below). Although not all routers and terminals within a network are NSIS entities (NE), a NE has NSIS functions. Not all NE support QoS for mobility functions. Here, a NE having QoS functions is referred to as a QoS NE (QNE).

A QoS resource is reserved at each QNE along a path through which data being transferred passes. A flow identifier (ID) is used to identify a packet of QoS guaranteed on the path. Because the flow ID includes IP addresses of data transmitting side and receiving side (refer to Non-patent Document 5, below), the flow ID changes when an IP address changes because of a mobility movement, such as a handover. At the same time, a session ID is used to identify a session between a mobile node (MN) and a correspondent node (CN). Therefore, the session ID remains the same even when the flow ID changes because of the mobility movement.

Here, as shown in FIG. 10, when a handover is performed, a crossover node (CRN) 12′ that is a QNE positioned at a branching point between a path (old path) 24′ and a path (new path) 34′ serves an important role in preventing a double reservation in a QoS handover. The CRN 12′ is required to perform different processes at an overlapping path segment (between CN 60′ and CRN 12′) and a new path segment (between CRN 12′ and MN 10′). In other words, an update of a state between the CN 60′ and the CRN 12′, and a QoS state reservation between the CRN 12′ and the MN 10′ are required to be performed. Therefore, discovery of the CRN 12′ is an important issue in the QoS handover. To prevent or minimize QoS interruptions caused by the handover, processing is required to be performed quickly. However, CRN discover requires time, and signaling load also increases.

Therefore, several techniques are proposed to resolve such issues. For example, there is a technology disclosed in Non-patent Document 7, below. In the technology disclosed in Non-patent Document 7, a proxy that actualizes quick CRN discovery is proposed. The MN transmits a request including an old flow ID and session ID pair to a new access router (NAR) acting as a proxy. The NAR transmits a QUERY message for discovering an uplink direction CRN to the CN. Each QNE on the path acquires the QUERY message, compares the old flow ID and session ID pair, and checks whether the QNE itself is the CRN. Upon receiving the QUERY message, the CN transmits not only a RESPONSE message for the received QUERY message, but also a QUERY message for discovering a downlink direction CRN to the NAR. At least a single round trip time (RTT) is required for the CRN discovery. The CRN discovery is required to be performed every time the MN performs a handover, causing load.

Therefore, to reduce signaling load, one method is a method in which a certain QNE is designated as the CRN. A QNE on an old QoS path is designated as a certain CRN. As the designated QNE, for example, a previous access router (PAR) can be considered. As a result of a configuration such as this, the signaling load can be reduced. Technologies such as this are disclosed in Patent Documents 1 and 2, below.
Non-patent Document 1: NSIS WG (http://www.ietf.org/html. charters/nsis-charter.html)
Non-patent Document 2: H. Chaskar, Ed, “Requirements of a Quality of Service (QoS) Solution for Mobile IP”, RFC 3583, September 2003
Non-patent Document 3: Sven Van den Bosch, Georgios Karagiannis and Andrew McDonald, “NSLP for Quality-of-Service signaling”, draft-ietf-nsis-QoS-nslp-06.txt, May 2005
Non-patent Document 4: S. Lee, et al., “Applicability Statement of NSIS Protocols in Mobile Environments”, draft-ietf-nsis-applicability-mobility-signaling-01.txt, February 2005
Non-patent Document 5: R. Hancock et al., “Next Steps in Signaling: Framework”, RFC 4080, June 2005
Non-patent Document 6: M. Brunner (Editor), “Requirements for Signaling Protocols”, RFC 3726, April 2004
Non-patent Document 7: T. Ue, T. Sanda, K. Honma, “QoS Mobility Support with Proxy-assisted Fast Crossover Node Discovery”, WPMC 2004, September 2004
Patent Document 1: Japanese Patent Publication No. 3441367 (FIG. 1)
Patent Document 2: Japanese Patent Laid-open Publication No. 2002-528976 (paragraphs 0024 and 0032)

However, as shown in FIG. 11, in a network of technologies disclosed in the Patent Documents 1 and 2 above, a QoS path 64′ immediately after the handover is almost the same as the old QoS path 24′ and is not an optimal path. Therefore, the MN 10′ is required to reconfigure the QoS path 34′ after the handover. A problem is present in that load is applied.

### DISCLOSURE OF THE INVENTION

In light of the above-described problems, an object of the present invention is to provide a high-speed QoS handover method and a processing node used in the method, in which a QoS path reconfigured before a handover becomes as optimal a QoS path as possible after the handover, thereby reducing load of route reconfiguration of the QoS path performed after the handover, shortening a segment of QoS path setting performed immediately after the handover, and minimizing a QoS interruption time.

To achieve the above-described object, the present invention provides a high-speed QoS handover method through QoS path modification when, in a communication system in which a plurality of access routers each configuring a subnet are connected by a communication network, and at least one or more access points forming a unique communication-capable area are connected to each of the plurality of access routers, a mobile node configured to communicate with the access router connected to the access point through wireless communication with the access point within the communication-capable area switches connection from a first access point connected to a first access router with which communication is currently being performed to a second access point connected to a second access router by a handover. The high-speed QoS handover method includes a step at which the mobile node transmits a first signaling for configuring a predetermined QoS path to a processing node that performs a predetermined process for reducing a load of a modification process for the QoS path after the handover. The high-speed QoS handover method also includes a step at which the processing node that receives the first signaling generates a second signaling for performing a QoS setting of the predetermined QoS path based on the received first signaling and transmits the generated second signaling to a predetermined correspondence partner that performs the QoS setting of the predetermined QoS path. As a result of the configuration, a QoS path reconfigured before a handover becomes as optimal a QoS path as possible after the handover. A load of route reconfiguration of the QoS path performed after the handover can be reduced. Moreover, a segment of QoS path setting performed immediately after the handover can be shortened, and a QoS interruption time can be minimized.

In addition, in the high-speed QoS handover method of the present invention, a preferred aspect of the present invention is that the predetermined QoS path passes from a terminal of a correspondence partner of the mobile node itself through the second access router to which the second access point is connected and the first access router to which the first access point is connected. As a result of the configuration, the QoS path reconfigured before the handover becomes as optimal a QoS path as possible after the handover.

In addition, in the high-speed QoS handover method of the present invention, a preferred aspect of the present invention is that the first signaling includes information on a QoS path before the handover. As a result of the configuration, the QoS path can be reconfigured before the handover.

In addition, in the high-speed QoS handover method of the present invention, a preferred aspect of the present invention is that the information on the QoS path before the handover is session identifying information and flow identifying information. As a result of the configuration, the QoS path can be reconfigured before the handover.

In addition, in the high-speed QoS handover method of the present invention, a preferred aspect of the present invention is that, after the predetermined QoS path is configured and the mobile node performs the handover, any of the processing node, the first access router to which the first access point is connected, and the second access router to which the second access point is connected deletes a QoS path, among the predetermined QoS path, between the second access router and the first access point to which the mobile node has been connected before the handover. As a result of the configuration, an unnecessary QoS can be deleted. Wasteful consumption of bandwidth can be reduced.

The present invention provides a processing node used in a high-speed QoS handover method through QoS path modification when, in a communication system in which a plurality of access routers each configuring a subnet are connected by a communication network, and at least one or more access points forming a unique communication-capable area are connected to each of the plurality of access routers, a mobile node configured to communicate with the access router connected to the access point through wireless communication with the access point within the communication-capable area switches connection from a first access point connected to a first access router with which communication is currently being performed to a second access point connected to a second access router by a handover. The processing node includes a receiving means that receives a first signaling for configuring a predetermined QoS path from the mobile node, a signaling generating means that generates a second signaling for performing a QoS setting for the predetermined QoS path, based on the received first signaling, and a transmitting means that transmits the generated second signaling to a predetermined correspondence partner performing the QoS setting for the predetermined QoS path. As a result of the configuration, a QoS path reconfigured before a handover becomes as optimal a QoS path as possible after the handover. A load of route reconfiguration of the QoS path performed after the handover can be reduced. Moreover, a segment of QoS path setting performed immediately after the handover can be shortened, and a QoS interruption time can be minimized.

In addition, in the processing node of the present invention, a preferred aspect of the present invention is that the predetermined QoS path passes from a terminal of a correspondence partner of the mobile node through the second access router to which the second access point is connected and the first access router to which the first access point is connected. As a result of the configuration, the QoS path reconfigured before the handover becomes as optimal a QoS path as possible after the handover.

In addition, in the processing node of the present invention, a preferred aspect of the present invention is that the first signaling includes information on a QoS path before the handover. As a result of the configuration, the QoS path can be reconfigured before the handover.

In addition, in the processing node of the present invention, a preferred aspect of the present invention is that the information on the QoS path before the handover is session identifying information and flow identifying information. As a result of the configuration, the QoS path can be reconfigured before the handover.

In addition, in the processing node of the present invention, a preferred aspect of the present invention is that the processing node further includes a path deleting means that, after the predetermined QoS path is configured and the mobile node performs the handover, deletes a QoS path, among the predetermined QoS path, between the second access router to which the second access point is connected and the first access point to which the mobile node has been connected before the handover. As a result of the configuration, an unnecessary QoS can be deleted. Wasteful consumption of bandwidth can be reduced.

The present invention provides a high-speed QoS handover method through QoS path modification when, in a communication system in which a plurality of access routers each configuring a subnet are connected by a communication network, and at least one or more access points forming a unique communication-capable area are connected to each of the plurality of access routers, a mobile node configured to communicate with the access router connected to the access point through wireless communication with the access point within the communication-capable area switches connection from an access point connected to an access router with which communication is currently being performed to another access point connected to another access router by a handover, subsequently separates from the other access point connected to the other access router, and switches connection to a predetermined access point connected to a predetermined access router. The high-speed QoS handover method includes a step at which the mobile node transmits a first signaling for configuring a predetermined QoS path to a processing node that performs a predetermined process for reducing a load of a modification process for the QoS path after the handover. The high-speed QoS handover method also includes a step at which the processing node that receives the first signaling generates a second signaling for performing a QoS setting of the predetermined QoS path based on the received first signaling and transmits the generated second signaling to a predetermined correspondence partner that performs the QoS setting of the predetermined QoS path. As a result of the configuration, a QoS path reconfigured before a handover becomes as optimal a QoS path as possible after the handover. A load of route reconfiguration of the QoS path performed after the handover can be reduced. Moreover, a segment of QoS path setting performed immediately after the handover can be shortened, and a QoS interruption time can be minimized.

In addition, in the high-speed QoS handover method of the present invention, a preferred aspect of the present invention is that the predetermined QoS path passes from a terminal of a correspondence partner of the mobile node itself through the predetermined access router to which the predetermined access point is connected, when an access point is present to which connection is made during movement from the other access point to the predetermined access point, an access router to which the access point to which the connection is made is connected, the other access router to which the other access point is connected, and the access router to which the access point with which communication is currently being performed is connected. As a result of the configuration, the QoS path reconfigured before the handover becomes as optimal a QoS path as possible after the handover.

In addition, in the high-speed QoS handover method of the present invention, a preferred aspect of the present invention is that the first signaling includes information on a QoS path before the handover. As a result of the configuration, the QoS path can be reconfigured before the handover.

In addition, in the high-speed QoS handover method of the present invention, a preferred aspect of the present invention is that the information on the QoS path before the handover is session identifying information and flow identifying information. As a result of the configuration, the QoS path can be reconfigured before the handover.

In addition, in the high-speed QoS handover method of the present invention, a preferred aspect of the present invention is that, after the predetermined QoS path is configured and the mobile node performs the handover, any of the processing node, an access router to which an access point to which connection is made before the handover of the mobile node is connected, and an access router to which an access point to which connection is made after the handover of the mobile node is connected deletes a QoS path, among the predetermined QoS path, between the access router of a movement destination and the access point to which the mobile node has been connected before the handover. As a result of the configuration, an unnecessary QoS can be deleted. Wasteful consumption of bandwidth can be reduced.

The present invention provides a processing node used in a high-speed QoS handover method through QoS path modification when, in a communication system in which a plurality of access routers each configuring a subnet are connected by a communication network, and at least one or more access points forming a unique communication-capable area are connected to each of the plurality of access routers, a mobile node configured to communicate with the access router connected to the access point through wireless communication with the access point within the communication-capable area switches connection from an access point connected to an access router with which communication is currently being performed to another access point connected to another access router by a handover, subsequently separates from the other access point connected to the other access router, and switches connection to a predetermined access point connected to a predetermined access router. The processing node includes a receiving means a receiving means that receives a first signaling for configuring a predetermined QoS path from the mobile node, a signal generating means that generates a second signaling for performing a QoS setting for the predetermined QoS path based on the received first signaling, and a transmitting means that transmits the generated second signaling to a predetermined correspondence partner performing the QoS setting for the predetermined QoS path. As a result of the configuration, a QoS path reconfigured before a handover becomes as optimal a QoS path as possible after the handover. A load of route reconfiguration of the QoS path performed after the handover can be reduced. Moreover, a segment of QoS path setting performed immediately after the handover can be shortened, and a QoS interruption time can be minimized.

In addition, in the processing node of the present invention, a preferred aspect of the present invention is that the predetermined QoS path passes from a terminal of a correspondence partner of the mobile node through the predetermined access router to which the predetermined access point is connected, when an access point is present to which connection is made during movement from the other access point to the predetermined access point, an access router to which the access point to which the connection is made is connected, the other access router to which the other access point is connected, and the access router to which the access point with which communication is currently being performed is connected. As a result of the configuration, the QoS path reconfigured before the handover becomes as optimal a QoS path as possible after the handover.

In addition, in the processing node of the present invention, a preferred aspect of the present invention is that the first signaling includes information on a QoS path before the handover. As a result of the configuration, the QoS path can be reconfigured before the handover.

In addition, in the processing node of the present invention, a preferred aspect of the present invention is that the information on the QoS path before the handover is session identifying information and flow identifying information. As a result of the configuration, the QoS path can be reconfigured before the handover.

In addition, in the processing node of the present invention, a preferred aspect of the present invention is that the processing node further includes a path deleting means that, after the predetermined QoS path is configured and the mobile node performs the handover, deletes a QoS path, among the predetermined QoS path, the access router of a movement destination and the access point to which the mobile node has been connected before the handover. As a result of the configuration, an unnecessary QoS can be deleted. Wasteful consumption of bandwidth can be reduced.

The highs-speed QoS handover method and the processing node used in the method are configured as described above. A QoS path reconfigured before a handover becomes as optimal a QoS path as possible after the handover. A load of route reconfiguration of the QoS path performed after the handover can be reduced. Moreover, a segment of QoS path setting performed immediately after the handover can be shortened, and a QoS interruption time can be minimized.

### BRIEF DESCRIPTION OF THE DRAWINGS

FIG. 1 is a schematic diagram of a configuration of a communication network according to first and second embodiments of the present invention;

FIG. 2 is a sequence chart of a signaling sequence in a high-speed QoS handover method according to the first embodiment of the present invention;

FIG. 3 is a block diagram of a configuration of a processing node according to the first embodiment of the present invention;

FIG. 4 is a sequence chart of a signaling sequence in a high-speed QoS handover method according to the second embodiment of the present invention;

FIG. 5 is a block diagram of a configuration of a processing node according to the second embodiment of the present invention;

FIG. 6 is a schematic diagram of a configuration of a communication network according to a third embodiment of the present invention;

FIG. 7 is a sequence chart of a signaling sequence in a high-speed QoS handover method according to the third embodiment of the present invention;

FIG. 8 is a block diagram of a configuration of a processing node according to the third embodiment of the present invention;

FIG. 9 is a sequence chart of another signaling sequence in the high-speed QoS handover method according to the third embodiment of the present invention;

FIG. 10 is a diagram of a conventional communication network; and

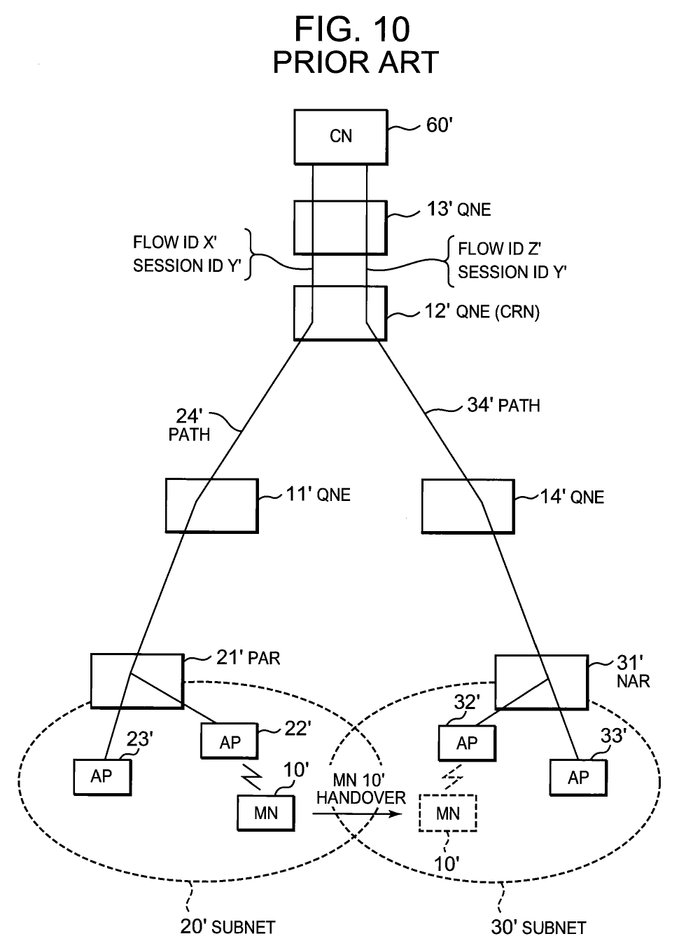

FIG. 11 is a diagram of a QoS path immediately after a handover of a mobile node in the conventional communication network.

### BEST MODE FOR CARRYING OUT THE INVENTION

### First Embodiment

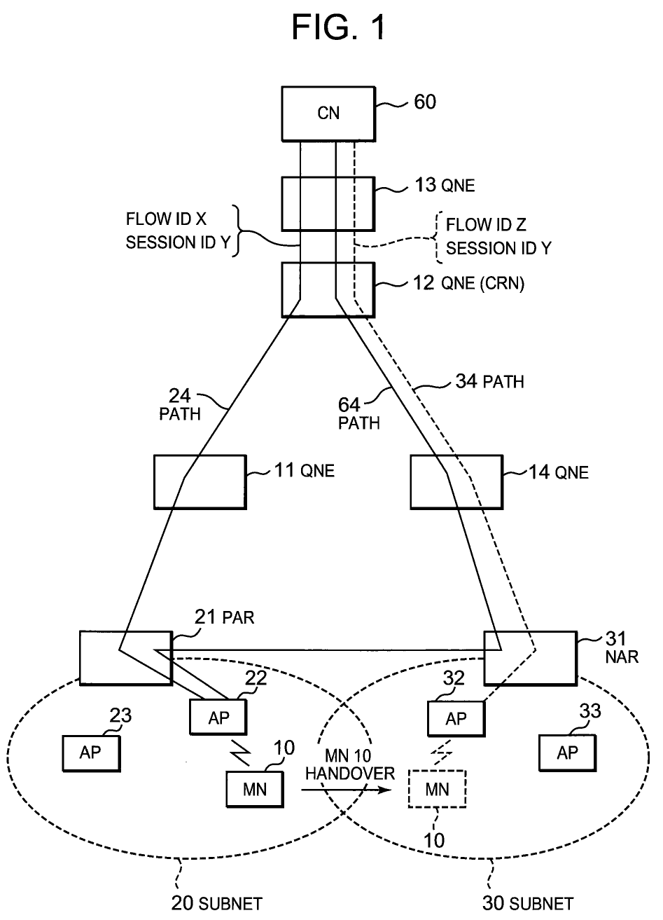

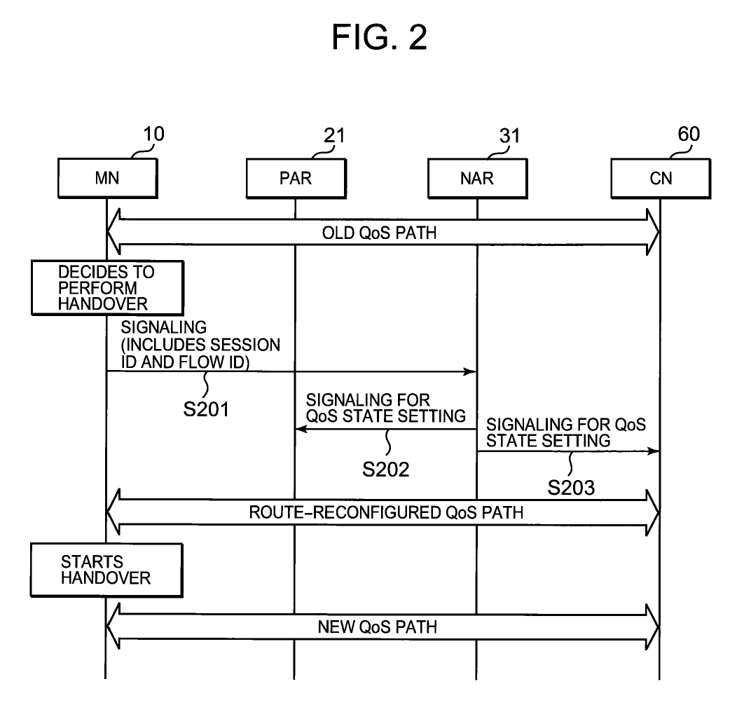

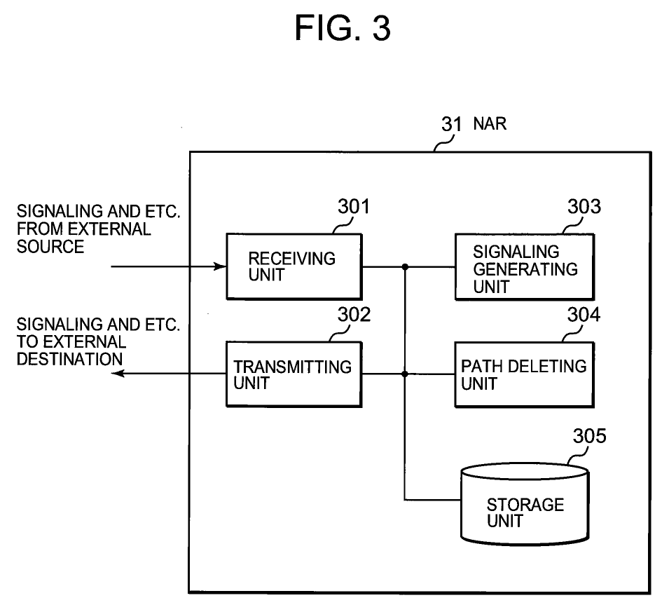

A first embodiment of the present invention will be described hereafter with reference to FIG. 1 to FIG. 3. FIG. 1 is a schematic diagram of a configuration of a communication network according to the first embodiment of the present invention. FIG. 2 is a sequence chart of a signaling sequence in a high-speed QoS handover method according to the first embodiment of the present invention. FIG. 3 is a block diagram of a configuration of a processing node according to the first embodiment of the present invention.

First, the configuration of the communication network according to the first embodiment of the present invention will be described with reference to FIG. 1. The communication network includes a MN (mobile node) 10, a CN 60, QNE 11, 12, 13, and 14, PAR 21 and NAR 31, and access points (AP) 22, 23, 32, and 33. The CN 60 is a correspondence partner of the MN 10. The QNE 11, 12, 13, and 14 are positioned between the MN 10 and the CN 60 and relay signalings (also referred to as a signaling message), data packets, and the like between the MN 10 and the CN 60. The PAR 21 and the NAR 31 are access routers respectively configuring subnets 20 and 30. The AP 22, 23, 32, and 33 are connected to the PAR 21 and the NAR 31 and form a unique communication-capable area. The configuration of the communication network here is an example and is not limited thereto.

The MN 10 is currently present in the subnet 20. The MN 10 is wirelessly connected to the AP 22 and is communicating with the CN 60 using a path (QoS) path 24. In other words, the MN 10 is communicating with the CN 60 through the AP 22, the PAR 21, the QNE 11, the QNE 12, and the QNE 13 on the QoS path 24. Hereafter, when the NAR 31 belonging to the subnet 30 is designated as a processing node that performs a process accompanying a QoS path modification according to the first embodiment of the present invention will be described. According to a second embodiment described hereafter, when the PAR 21 belonging to the subnet 20 is designated as the processing node will be described. The processing node is not limited to the NAR 31 and the PAR 21, and can be another QNE (proxy) and the like.

When the MN 10 moves (handover) from the subnet 20 to the subnet 30, the MN 10 transmits a signaling to the NAR 31 before the handover to configure a path (QoS path) 64 (here, a path from the CN 60 to the AP 22) from the CN 60 passing through the NAR 31 and the PAR 21 to which the AP 22 is connected. The signaling includes QoS path information, such as a session ID and a flow ID of the current QoS path 24. Specifically, the signaling includes, for example, Y that is the session ID and X that is the flow ID of the QoS path 24, as shown in FIG. 1. A session ID of a new path (QoS path) 34 after the MN 10 handover is Y and a flow ID is Z. As described above, the session ID remains the same even after the movement of the MN 10.

The NAR 31 that has received the signaling starts two processes. A first process is a process for configuring a QoS path from the NAR 31 towards the CN 60. Specifically, the NAR 31 transmits a signaling towards the CN 60 (equivalent to the above-described predetermined correspondence partner) for configuring the QoS path (QoS state setting). Then, state setting for a new QoS path based on the transmitted signaling is performed at the QNE 14, the QNE 12, and the QNE 13 positioned between the NAR 31 and the CN 60. The QoS path (a QoS path that is a portion of the path 64) is configured between the CN 60 and the NAR 31. The configured QoS path becomes an optimal path between the NAR 31 and the CN 60.

A second process is a process for configuring a temporary QoS path (a QoS path to the AP 22) from the NAR 31 towards the PAR 21. Specifically, the NAR 31 transmits a signaling towards the PAR 21 (equivalent to the above-described predetermined correspondence partner) for configuring the temporary QoS path (QoS state setting). The state setting for the temporary QoS path is performed as a result of the transmitted signaling. The temporary QoS path (a portion of the path 64) is configured between the AP 22 and the NAR 31. The configured temporary QoS path is deleted by the NAR 31, the PAR 21, or the like after the MN 10 handover is completed. Therefore, wasteful consumption of bandwidth by an unnecessary QoS path can be prevented. Hereafter, a signaling sequence in the above-described processes will be described with reference to FIG. 2.

As shown in FIG. 2, the QoS path 24 (old QoS path) is already configured between the MN 10 and the CN 60. When the MN 10 decides to perform the handover from this state, the MN 10 transmits a signaling including a session ID and a flow ID to the NAR 31 (Step S201). The transmitted signaling can also include information requesting that the NAR 31 become a branching point between the route-reconfigured QoS path 64 and the new QoS path 34 after the MN 10 handover.

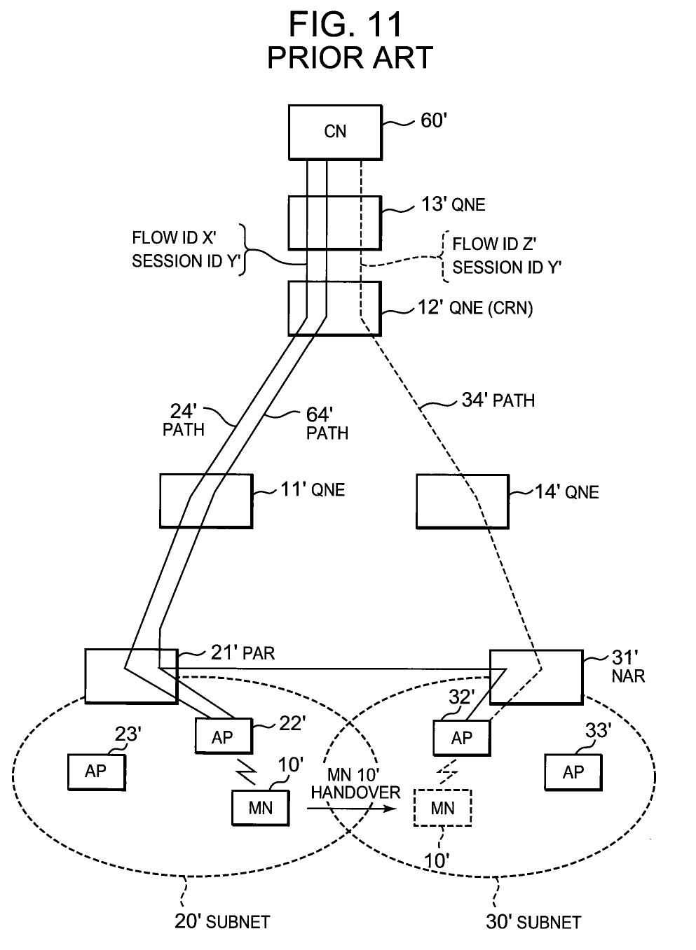

The NAR 31 that has received the signaling from the MN 10 transmits a signaling to the PAR 21 for configuring a temporary QoS path (QoS state setting) from the NAR 31 to the AP 22 (Step S202), and transmits a signaling to the CN 60 for configuring a QoS path (QoS state setting) from the NAR 31 to the CN 60 (Step S203). As a result of the signalings, state setting of the route-reconfigured QoS path 64 is performed. The QoS path 64 is configured between the CN 60 and the AP 22. Then, after the MN 10 starts and completes the handover, the temporary QoS path from the NAR 31 to the AP 22 is deleted. The new QoS path 34 is configured between the CN 60 and the AP 32. As a result of being configured as such, the QoS path after the MN 10 handover is as optimal a QoS path as possible. The load of route reconfiguration of the QoS path performed after the handover can be reduced. Moreover, although a segment of QoS path setting performed immediately after the handover is conventionally PAR 21′-NAR 31′-AP 32′-MN 10′, as shown in FIG. 11, according to the first embodiment of the present invention, the segment is shortened to NAR 31-AP 32-MN 10, as shown in FIG. 1. Therefore, time required for QoS path configuration is reduced and a QoS interruption time can also be reduced. Furthermore, because the generated QoS path passes through both the PAR 21 and the NAR 31, this is also effective in a so-called “ping pong phenomenon” in which the MN 10 moves back and forth between the PAR 21 and the NAR 31.

Next, a configuration of the processing node according to the first embodiment of the present invention will be described with reference to FIG. 3. Hereafter, the NAR 31 belonging to the subnet 30 after the MN 10 handover will be given as an example of the processing node and described. As shown in FIG. 3, the NAR 31 includes a receiving unit 301, a transmitting unit 302, a signaling generating unit 303, a path deleting unit 304, and a storage unit 305. The receiving unit 301 receives the above-described signaling for configuring the QoS path 64 from the MN 10, packets exchanged between the CN 60 and the MN 10, and the like. The transmitting unit 302 transmits signalings for configuring the QoS path 64 generated by the signaling generating unit 303, described hereafter, packets exchanged between the CN 60 and the MN 10, and the like.

The signaling generating unit 303 generates respective signalings for configuring a QoS path between the CN 60 and the NAR 31 and a QoS path between the NAR 31 and the AP 22, based on the signaling for configuring the QoS path 64 transmitted from the MN 10 and received by the receiving unit 301. The path deleting unit 304 deletes the temporary QoS path from the NAR 31 to the AP 22 when the MN 10 completes the handover after the QoS path 64 is configured between the CN 60 and the AP 22. Deletion of the temporary QoS path can be performed by the PAR 21, another device, or the like. The storage unit 305 stores a control program for controlling an operation of the NAR 31 and information, such as data generated when the NAR 31 performs the processes.

### Second Embodiment

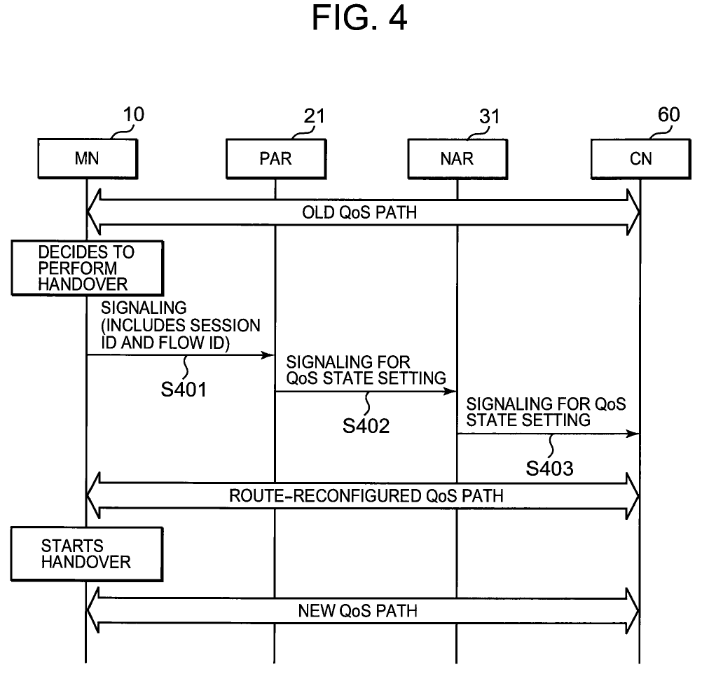

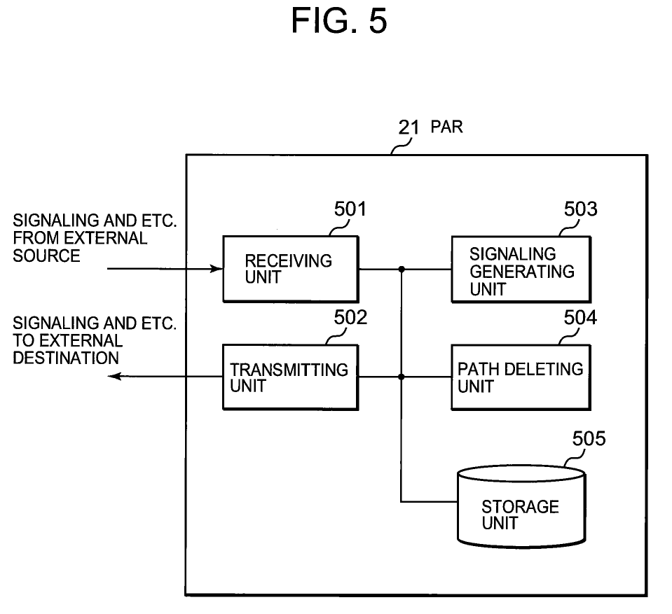

A second embodiment of the present invention will be described below with reference to FIG. 4 and FIG. 5. FIG. 4 is a sequence chart of a signaling sequence in a high-speed QoS handover method according to the second embodiment of the present invention. FIG. 5 is a block diagram of a configuration of a processing node according to the second embodiment of the present invention.

According to the second embodiment, as described above, when the PAR 21 belonging to the subnet 20 is designated as the processing node will be described. A communication network according to the second embodiment is similar to the communication network according to the first embodiment. The signaling sequence according to the second embodiment will be described with reference to FIG. 4. As shown in FIG. 4, before the handover is performed, the path (old QoS path) 24 is configured between the MN 10 and the CN 60.

When the MN 10 decides to perform the handover from this state, the MN 10 transmits a signaling (including a session ID and a flow ID) to the PAR 21 (Step S401). The PAR 21 that has received the signaling transmits a signaling towards the NAR 31 (equivalent to the above-described predetermined correspondence partner) for QoS state setting (Step S402). The NAR 31 that has received the signaling similarly transmits a signaling towards the CN 60 for QoS state setting (Step S403). As a result, the state setting for a new QoS path based on the transmitted signaling is performed at the QNE 14, the QNE 12, and the QNE 13 positioned between the NAR 31 and the CN 60. The route-reconfigured QoS path 64 is configured between the CN 60 and the AP 22.

Then, when the MN 10 actually starts and completes the handover, the temporary QoS path from the NAR 31 to the AP 22 is deleted. The new QoS path 34 is configured between the CN 60 and the AP 32. As a result of being configured as such, the QoS path after the MN 10 handover is as optimal a QoS path as possible. The load of route reconfiguration of the QoS path performed after the handover can be reduced. Moreover, although a segment of QoS path setting performed immediately after the handover is conventionally PAR 21′-NAR 31′-AP 32′-MN 10′, as shown in FIG. 11, according to the second embodiment of the present invention, the segment is shortened to NAR 31-AP 32-MN 10, as shown in FIG. 1. Therefore, time required for QoS path configuration is reduced and a QoS interruption time can also be reduced. Furthermore, because the generated QoS path passes through both the PAR 21 and the NAR 31, this is also effective in a so-called “ping pong phenomenon” in which the MN 10 moves back and forth between the PAR 21 and the NAR 31.

Next, a configuration of the processing node according to the second embodiment of the present invention will be described with reference to FIG. 5. Hereafter, the PAR 21 belonging to the subnet 20 before the MN 10 handover will be given as an example of the processing node and described. As shown in FIG. 5, the PAR 21 includes a receiving unit 501, a transmitting unit 502, a signaling generating unit 503, a path deleting unit 504, and a storage unit 505. The receiving unit 501 receives the above-described signaling for configuring the QoS path 64 from the MN 10, packets exchanged between the CN 60 and the MN 10, and the like. The transmitting unit 502 transmits signalings for configuring the QoS path 64 generated by the signaling generating unit 503, described hereafter, packets exchanged between the CN 60 and the MN 10, and the like.

The signaling generating unit 503 generates a signaling for configuring a QoS path between the CN 60 and the AP 22, based on the signaling for configuring the QoS path 64 transmitted from the MN 10 and received by the receiving unit 501. The NAR 31 receiving the generated signaling generates a signaling for configuring a QoS path between the CN 60 and the NAR 31 itself and transmits the signaling to the CN 60.

The path deleting unit 504 deletes the temporary QoS path from the NAR 31 to the AP 22 when the MN 10 starts and completes the handover after the QoS path 64 is configured between the CN 60 and the AP 22. Deletion of the temporary QoS path can be performed by the NAR 31, another device, or the like. The storage unit 505 stores a control program for controlling an operation of the PAR 21 and information, such as data generated when the PAR 21 performs processes.

### Third Embodiment

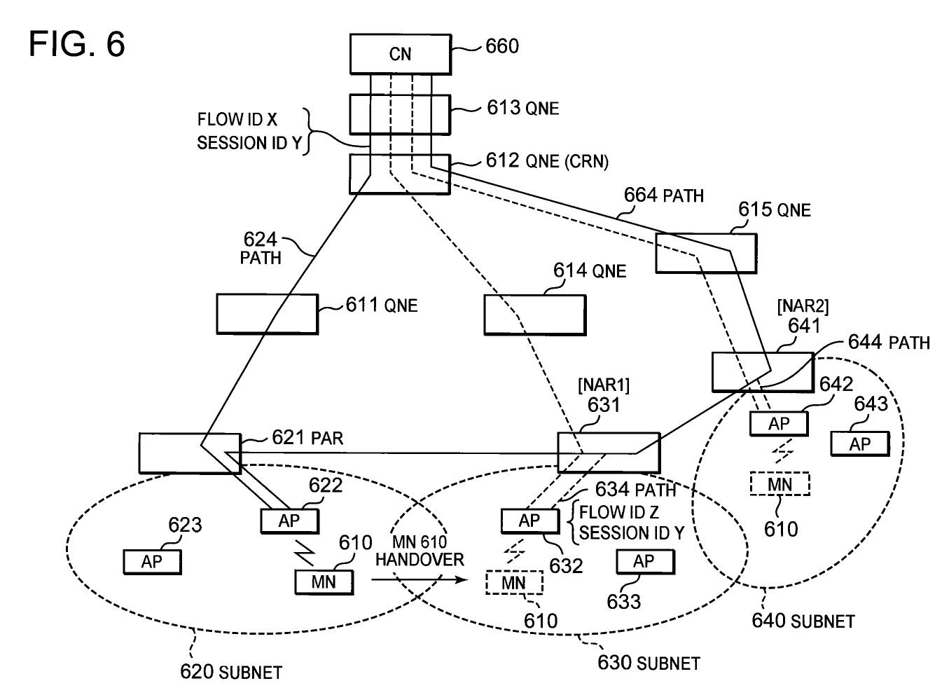

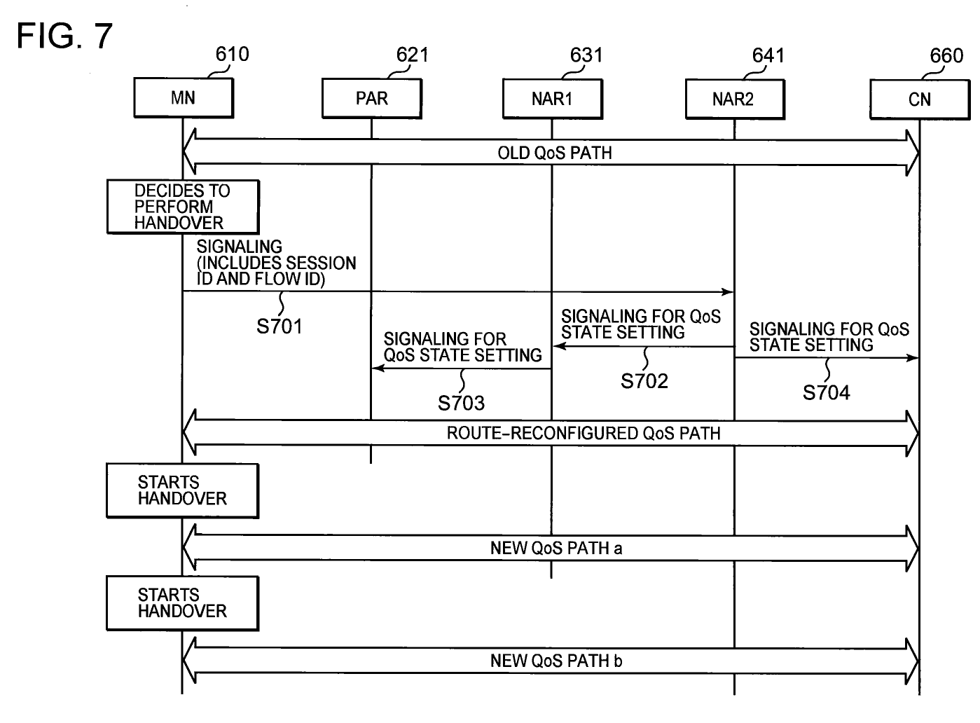

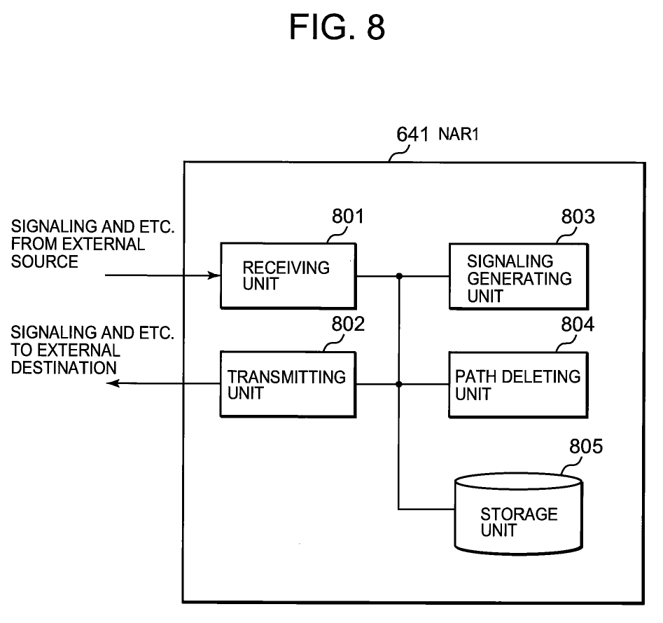

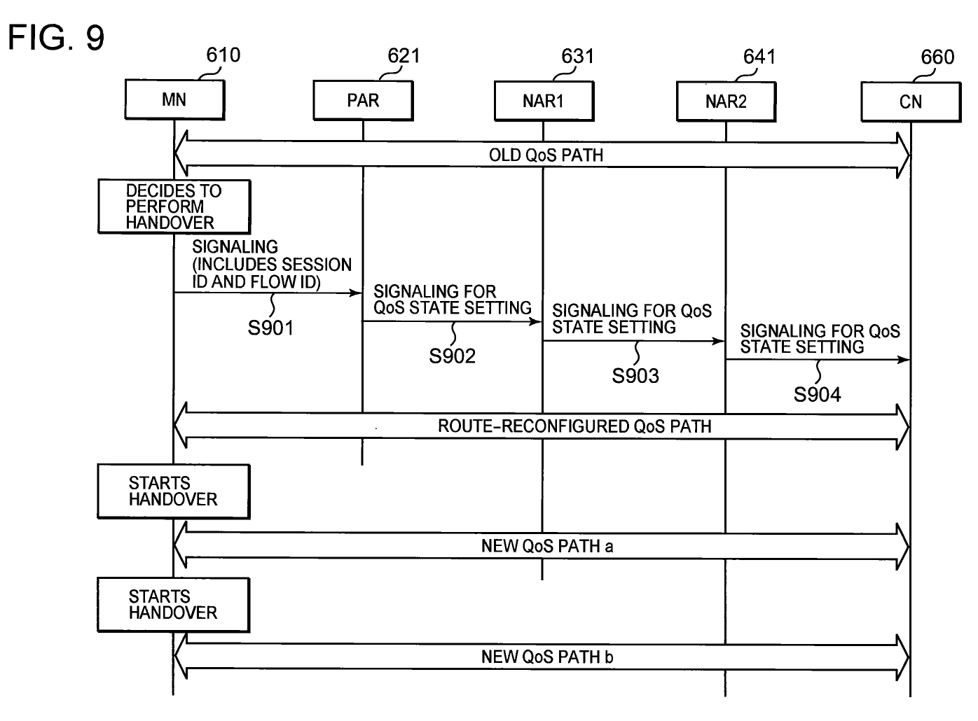

A third embodiment of the present invention will be described below with reference to FIG. 6 to FIG. 9. FIG. 6 is a schematic diagram of a configuration of a communication network according to the third embodiment of the present invention. FIG. 7 is a sequence chart of a signaling sequence in a high-speed QoS handover method according to the third embodiment of the present invention. FIG. 8 is a block diagram of a configuration of a processing node according to the third embodiment of the present invention. FIG. 9 is a sequence chart of another signaling sequence in the high-speed QoS handover method according to the third embodiment of the present invention.

First, the configuration of the communication network according to the third embodiment of the present invention will be described with reference to FIG. 6. The communication network includes a MN (mobile node) 610, a CN 660, QNE 611, 612, 613, 614, and 615, PAR 621, [NAR1] 631, and [NAR2] 641, and access points (AP) 622, 623, 632, 633, 642, and 643. The CN 660 is a correspondence partner of the MN 610. The QNE 611, 612, 613, 614, and 615 are positioned between the MN 610 and the CN 660 and relay signalings (also referred to as a signaling message), data packets, and the like between the MN 610 and the CN 660. The PAR 621, the [NAR1] 631, and the [NAR2] 641 are access routers respectively configuring subnets 620, 630, and 640. The AP 622, 623, 632, 633, 642, and 643 are connected to the PAR 621, the [NAR1] 631, and the [NAR2] 641 and form a unique communication-capable area. The configuration of the communication network here is an example and is not limited thereto.

The MN 610 is currently present in the subnet 620. The MN 610 is wirelessly connected to the AP 622 and is communicating with the CN 660 using a path (QoS) path 624. In other words, the MN 610 is communicating with the CN 660 through the AP 622, the PAR 621, the QNE 611, the QNE 612, and the QNE 613 on the QOS path 624. Hereafter, when the [NAR2] 641 belonging to the subnet 640 is designated as a processing node that performs a process accompanying a QoS path modification according to the third embodiment of the present invention will be described. When the PAR 621 belonging to the subnet 620 is designated as the processing node will be described thereafter. The processing node is not limited to the [NAR1] 631, the [NAR2] 641, and the PAR 621, and can be another QNE (proxy) and the like.

When the MN 610 moves (handover) from the subnet 620 to the subnet 630, the MN 610 transmits a signaling to the [NAR2] 641 before the handover to configure a path (QoS path) 664 (here, a path from the CN 660 to the AP 622) from the CN 660 passing through the [NAR2] 641, the [NAR1] 631, and the PAR 621 to which the AP 622 is connected. The signaling includes QoS path information, such as a session ID and a flow ID of the current QoS path 624. Specifically, the signaling includes, for example, Y that is the session ID and X that is the flow ID of the QoS path 624, as shown in FIG. 6. A session ID of a new path (QoS path) 634 after the MN 610 handover is Y and a flow ID is Z. As described above, the session ID remains the same even after the movement of the MN 610.

The [NAR2] 641 that has received the signaling starts two processes. A first process is a process for configuring a QoS path from the [NAR2] 641 towards the CN 660 (equivalent to the above-described predetermined correspondence partner). Specifically, the [NAR2] 641 transmits a signaling towards the CN 660 for configuring the QoS path (QoS state setting). Then, state setting for a new QoS path based on the transmitted signaling is performed at the QNE 615, the QNE 612, and the QNE 613 positioned between the [NAR2] 641 and the CN 660. The QoS path (a QoS path that is a portion of the path 664) is configured between the CN 660 and the [NAR2] 641. The configured QoS path becomes an optimal path between the [NAR2] 641 and the CN 660.

A second process is a process for configuring a temporary QoS path (a QoS path to the AP 622) from the [NAR2] 641 towards the PAR 621, via the [NAR1] 631. Specifically, the [NAR2] 641 transmits a signaling towards the PAR 621 via the [NAR1] 631 for configuring the temporary QoS path (QoS state setting). The state setting for the temporary QoS path is performed as a result of the transmitted signaling. The temporary QoS path (a portion of the path 664) is configured between the AP 622 and the [NAR2] 641. In this way, when, for example, the [NAR2] 641 that is two access routers over is known, a process for path modification at the [NAR1] 631 that is one access router over can be omitted as a result of including the [NAR2] 641 on the path. The portion of the QoS path from the [NAR1] 631 to the AP622 within the configured temporary QoS path is deleted by the [NAR1] 631, the PAR 621, or the like when the MN 10 handover is completed. Therefore, wasteful consumption of bandwidth by an unnecessary QoS path can be prevented. Hereafter, a signaling sequence in the above-described processes will be described with reference to FIG. 7.

As shown in FIG. 7, the QoS path 624 (old QoS path) is already configured between the MN 610 and the CN 660. When the MN 610 decides to perform the handover from this state, the MN 610 transmits a signaling including a session ID and a flow ID to the [NAR2] 641 (Step S701).

The [NAR2] 641 that has received the signaling from the MN 610 transmits a signaling to the [NAR1] 631 for configuring a QoS path (QoS state setting) from the [NAR2] 641 to the AP 622 (Step S702). The [NAR1] 631 that has received the signaling transmits the received signaling to the PAR 621 (Step S703). The [NAR2] 641 also transmits a signaling to the CN 660 for configuring a QoS path (QoS state setting) from the [NAR2] 641 to the CN 660 (Step S704). As a result of the signalings, state setting of the route-reconfigured QoS path 664 is performed. The QoS path 664 is configured between the CN 660 and the AP 622. Then, after the MN 610 starts and completes the handover, the QoS path from the [NAR1] 631 to the AP 622 is deleted. The new QoS path 634 (new QoS path a) is configured between the CN 660 and the AP 632. When the MN 610 subsequently further completes a handover from the AP 632 to the AP642, the QoS path from the [NAR2] 641 to the AP 632 is deleted. A new QoS path (path) 644 (new QoS path b) is configured between the CN 660 and the AP 642.

As a result of being configured as such, the QoS path after the MN 610 handover is as optimal a QoS path as possible. The load of route reconfiguration of the QoS path performed after the handover can be reduced. Moreover, although a segment of QoS path setting performed immediately after the handover is conventionally PAR 621-NAR 631-AP 632-MN 610, according to the third embodiment of the present invention, the segment is shortened to [NAR1] 631-AP 632-MN 610, as shown in FIG. 6. Therefore, time required for QoS path configuration is reduced and a QoS interruption time can also be reduced. Furthermore, because the generated QoS path passes through the PAR 621, the [NAR1] 631, and the [NAR2] 641, this is also effective in a so-called “ping pong phenomenon” in which the MN 10 moves back and forth between the PAR 621, the [NAR1] 631, and the [NAR2] 641.

Next, a configuration of the processing node according to the third embodiment of the present invention will be described with reference to FIG. 8. Hereafter, the [NAR2] 641 belonging to the subnet 640 will be given as an example of the processing node and described. As shown in FIG. 8, the [NAR2] 641 includes a receiving unit 801, a transmitting unit 802, a signaling generating unit 803, a path deleting unit 804, and a storage unit 805. The receiving unit 801 receives the above-described signaling for configuring the QoS path 664 from the MN 610, packets exchanged between the CN 660 and the MN 610, and the like. The transmitting unit 802 transmits signalings for configuring the QoS path 664 generated by the signaling generating unit 803, described hereafter, packets exchanged between the CN 660 and the MN 610, and the like.

The signaling generating unit 803 generates respective signalings for configuring a QoS path between the CN 660 and the [NAR2] 641 and a QoS path between the [NAR2] 641 and the AP 622, based on the signaling for configuring the QoS path 664 transmitted from the MN 610 and received by the receiving unit 801. The path deleting unit 804 deletes the temporary QoS path from the [NAR2] 641 to the [NAR1] 631 when, for example, the MN 610 repeats the handover after the QoS path 664 is configured between the CN 660 and the AP 622 and completes the handover from the AP 632 within the subnet 630 to the AP 642 within the subnet 640. Deletion of the temporary QoS path can be performed by the [NAR1] 631, another device, or the like. The storage unit 805 stores a control program for controlling an operation of the [NAR2] 641 and information, such as data generated when the [NAR2] 641 performs the processes.

Next, a signaling sequence of when the PAR 621 belonging to the subnet 620 is designated as the processing node, as described above, will be described with reference to FIG. 9. First, as shown in FIG. 9, the QoS path 624 (old QoS path) is already configured between the MN 610 and the CN 660. When the MN 610 decides to perform the handover from this state, the MN 610 transmits a signaling including a session ID and a flow ID to the PAR 621 (Step S901).

The PAR 621 that has received the signaling from the MN 610 transmits a signaling to the [NAR1] 631, towards the CN 660 (equivalent to the predetermined correspondence partner), for configuring a QoS path (QoS state setting) from the PAR 621 (AP 622) to the CN 660 (Step S902). The [NAR1] 631 that has received the signaling transmits the received signaling to the [NAR2] 641 (Step S903). The [NAR2] 641 that has received the signaling transmits the received signaling to the CN 660 (Step S904). As a result of the signalings, state setting of the route-reconfigured QoS path 664 is performed. The QoS path 664 is configured between the CN 660 and the AP 622. Then, after the MN 610 starts and completes the handover, the QoS path from the [NAR1] 631 to the AP 622 is deleted. The new QoS path 634 (new QoS path a) is configured between the CN 660 and the AP 632. When the MN 610 subsequently further completes a handover from the AP 632 to the AP642, the QoS path from the [NAR2] 641 to the AP 632 is deleted. A new QoS path 644 (new QoS path b) is configured between the CN 660 and the AP 642. As a result of being configured as such, when, for example, the [NAR2] 641 that is two access routers over is known, a process for path modification at the [NAR1] 631 that is one access router over can be omitted as a result of including the [NAR2] 641 on the path.

Each embodiment of the present invention has been described above. Each functional block used in the explanations of each embodiment of the present embodiment, described above, can be actualized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed or a reconfigurable processor of which connections and settings of the circuit cells within the LSI can be reconfigured can be used after LSI manufacturing. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

In the high-speed QoS handover method and the processing node used in the method of the present invention, the QoS path reconfigured before the handover becomes as optimal a QoS path as possible after the handover, and the load of route-reconfiguration of the QoS path performed after the handover can be reduced. Moreover, the segment of the QoS path setting performed immediately after the handover is shortened, and the QoS interruption time can be minimized. Therefore, the high-speed QoS handover method and the processing node used in the method of the present invention can be used in a high-speed QoS handover method and a processing node used in the method for a mobile terminal (mobile node) performing wireless communication. In particular, the high-speed QoS handover method and the processing node used in the method of the present invention is effective in a high-speed QoS handover method and a processing node used in the method for a mobile node that performs wireless communication using mobile internet protocol version 6 (IPv6) that is a next-generation internet protocol.

1. A high-speed QoS handover method through QoS path modification when, in a communication system in which a plurality of access routers each configuring a subnet are connected by a communication network, and at least one or more access points forming a unique communication-capable area are connected to each of the plurality of access routers, a mobile node configured to communicate with the access router connected to the access point through wireless communication with the access point within the communication-capable area switches connection from a first access point connected to a first access router with which communication is currently being performed to a second access point connected to a second access router by a handover, the high-speed QoS handover method comprising a step of:
transmitting, by the mobile node, a first signaling for configuring a predetermined QoS path to a processing node that performs a predetermined process for reducing a load of a modification process for the QoS path after the handover; and
generating, by the processing node that receives the first signaling, a second signaling for performing a QoS setting of the predetermined QoS path based on the received first signaling and transmitting the generated second signaling to a predetermined correspondence partner that performs the QoS setting of the predetermined QoS path.

2. The high-speed QoS handover method according to claim 1, wherein:
the predetermined QoS path passes from a terminal of a correspondence partner of the mobile node itself through the second access router to which the second access point is connected and the first access router to which the first access point is connected.

3. The high-speed QoS handover method according to claim 1, wherein the first signaling includes information on a QoS path before the handover.

4. The high-speed QoS handover method according to claim 3, wherein the information on the QoS path before the handover is session identifying information and flow identifying information.

5. The high-speed QoS handover method according to claim 1, wherein:
after the predetermined QoS path is configured and the mobile node performs the handover, any of the processing node, the first access router to which the first access point is connected, and the second access router to which the second access point is connected deletes a QoS path, among the predetermined QoS path, between the second access router and the first access point to which the mobile node has been connected before the handover.

6. A processing node used in a high-speed QoS handover method through QoS path modification when, in a communication system in which a plurality of access routers each configuring a subnet are connected by a communication network, and at least one or more access points forming a unique communication-capable area are connected to each of the plurality of access routers, a mobile node configured to communicate with the access router connected to the access point through wireless communication with the access point within the communication-capable area switches connection from a first access point connected to a first access router with which communication is currently being performed to a second access point connected to a second access router by a handover, the processing node comprising:
a receiving means that receives a first signaling for configuring a predetermined QoS path from the mobile node;
a signaling generating means that generates a second signaling for performing a QoS setting for the predetermined QoS path, based on the received first signaling; and
a transmitting means that transmits the generated second signaling to a predetermined correspondence partner performing the QoS setting for the predetermined QoS path.

7. The processing node according to claim 6, wherein:
the predetermined QoS path passes from a terminal of a correspondence partner of the mobile node through the second access router to which the second access point is connected and the first access router to which the first access point is connected.

8. The processing node according to claim 6, wherein the first signaling includes information on a QoS path before the handover.

9. The processing node according to claim 8, wherein the information on the QoS path before the handover is session identifying information and flow identifying information.

10. The processing node according to claim 6, further comprising:
a path deleting means that, after the predetermined QoS path is configured and the mobile node performs the handover, deletes a QoS path, among the predetermined QoS path, between the second access router to which the second access point is connected and the first access point to which the mobile node has been connected before the handover.

11. A high-speed QoS handover method through QoS path modification when, in a communication system in which a plurality of access routers each configuring a subnet are connected by a communication network, and at least one or more access points forming a unique communication-capable area are connected to each of the plurality of access routers, a mobile node configured to communicate with the access router connected to the access point through wireless communication with the access point within the communication-capable area switches connection from an access point connected to an access router with which communication is currently being performed to another access point connected to another access router by a handover, subsequently separates from the other access point connected to the other access router, and switches connection to a predetermined access point connected to a predetermined access router, the high-speed QoS handover method comprising a step of:
transmitting, by the mobile node, a first signaling for configuring a predetermined QoS path to a processing node that performs a predetermined process for reducing a load of a modification process for the QoS path after the handover; and
generating, by the processing node that receives the first signaling, a second signaling for performing a QoS setting of the predetermined QoS path based on the received first signaling and transmitting the generated second signaling to a predetermined correspondence partner that performs the QoS setting of the predetermined QoS path.

12. The high-speed QoS handover method according to claim 11, wherein:
the predetermined QoS path passes from a terminal of a correspondence partner of the mobile node itself through the predetermined access router to which the predetermined access point is connected, when an access point is present to which connection is made during movement from the other access point to the predetermined access point, an access router to which the access point to which the connection is made is connected, the other access router to which the other access point is connected, and the access router to which the access point with which communication is currently being performed is connected.

13. The high-speed QoS handover method according to claim 11, wherein the first signaling includes information on a QoS path before the handover.

14. The high-speed QoS handover method according to claim 13, wherein the information on the QoS path before the handover is session identifying information and flow identifying information.

15. The high-speed QoS handover method according to claim 11, wherein:
after the predetermined QoS path is configured and the mobile node performs the handover, any of the processing node, an access router to which an access point to which connection is made before the handover of the mobile node is connected, and an access router to which an access point to which connection is made after the handover of the mobile node is connected deletes a QoS path, among the predetermined QoS path, between the access router of a movement destination and the access point to which the mobile node has been connected before the handover.

16. A processing node used in a high-speed QoS handover method through QoS path modification when, in a communication system in which a plurality of access routers each configuring a subnet are connected by a communication network, and at least one or more access points forming a unique communication-capable area are connected to each of the plurality of access routers, a mobile node configured to communicate with the access router connected to the access point through wireless communication with the access point within the communication-capable area switches connection from an access point connected to an access router with which communication is currently being performed to another access point connected to another access router by a handover, subsequently separates from the other access point connected to the other access router, and switches connection to a predetermined access point connected to a predetermined access router, the processing node comprising:
a receiving means that receives a first signaling for configuring a predetermined QoS path from the mobile node;
a signal generating means that generates a second signaling for performing a QoS setting for the predetermined QoS path based on the received first signaling; and
a transmitting means that transmits the generated second signaling to a predetermined correspondence partner performing the QoS setting for the predetermined QoS path.

17. The processing node according to claim 16, wherein:
the predetermined QoS path passes from a terminal of a correspondence partner of the mobile node through the predetermined access router to which the predetermined access point is connected, when an access point is present to which connection is made during movement from the other access point to the predetermined access point, an access router to which the access point to which the connection is made is connected, the other access router to which the other access point is connected, and the access router to which the access point with which communication is currently being performed is connected.

18. The processing node according to claim 16, wherein the first signaling includes information on a QoS path before the handover.

19. The processing node according to claim 18, wherein the information on the QoS path before the handover is session identifying information and flow identifying information.

20. The processing node according to claim 16, further comprising:
a path deleting means that, after the predetermined QoS path is configured and the mobile node performs the handover, deletes a QoS path, among the predetermined QoS path, the access router of a movement destination and the access point to which the mobile node has been connected before the handover.
